(19) United States
(12) Patent Application Publication
(10) Pub. No.: US 2007/0104911 A1
(43) Pub. Date: May 10, 2007

(54) Laminate with optical structure and method for using the same

(76) Inventors: Whe-Yi Chiang, Hsinchu City (TW); Ta-Ching Pong, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/269,540

(22) Filed: Nov. 9, 2005

(51) Int. Cl. B32B 33/00

(52) U.S. Cl. 428/40.1; 428/167

(57) ABSTRACT

This invention provides a laminate with optical structure and method for using the same. The laminate according to the invention can produce various two-dimensional (2D) or three-dimensional (3D) effects, such as flip, animation, morph, zoom, and 3D effects, by laminating with a specially computer treated image. The objective of this invention is to solve the alignment problem between the optical structure and the image during lamination. By using the laminate from the invention, it is possible to easily align the optical structure with the image to economically obtain an object with 2D animation or 3D effect without using expansive printing equipment.

### BACKGROUND OF THE INVENTION

1. Field of the Invention

The present invention is generally related to a laminate with optical structure and a method for using the same, and more particularly to a laminate with lenticular lens to create 2D or 3D effects by laminating with a specially computer treated image.

2. Description of the Prior Art

There are various different forms of lenticular effects: 3D, flip, animation, morph and zoom. For example, as shown in FIG. 1 the method to create lenticular effects, such as flip effect, is to have A and B image files divided into stripes and interlaced together into an image file (FIG. 1A), to align the interlaced image printout with the lenticular lens sheet or directly print the interlaced image on the lenticular lens sheet (FIG. 1B). The different images A and B can be delivered to each eye from different viewing angle to create flip effect.

However, in order to align the interlaced image printout with the lenticular lens sheet, generally it requires using double-sided tape to adhere the interlaced image printout and the lenticular lens sheet together. At first, the double-sided tape is laminated with the lenticular lens sheet. In order to align the image stripe with the lenticular lens, the interlaced image needs to be positioned at the focal point of the lenticular lens to make the image viewable through the lenticular lens. Under such condition, the lenticular lens sheet backed with tape slightly adheres to the interlaced image printout, resulting in the difficulty of adjusting the relative position of the image stripe and the lenticular lens. Thus, it is difficult to do alignment between the interlaced image printout and the lenticular lens sheet.

On the other hand, in order to directly print the interlaced image on the lenticular lens sheet to produce a lenticular print, it requires a printer that can print inks on a plastic sheet. Such printer usually is an expansive printing equipment, such as offset waterless printer. It is generally for commercial use, not for consumer use.

### SUMMARY OF THE INVENTION

In light of the above-mentioned matter, the present invention provides a laminate with optical structure and a method for using the same to economically create lenticular effects for various applications, such as small business, consumer, and art creation.

One object of the present invention is provide a laminate with optical structure a method for using the same to easily and economically create lenticular effects.

According to above-mentioned objectives, the present invention discloses a laminate with optical structure comprising: a sheet with optical structure having a plurality of lenticular lens on one surface of the sheet; an adhesive layer formed on the other surface of the sheet and covering the whole or part of the surface; and, a release layer provided on the adhesive layer and covering at least the whole surface of the adhesive layer, and divided by a release layer separation member into a first portion and a second portion, wherein the area of the first portion is larger than that of the second portion.

In the laminate with optical structure according to the invention, the release layer separation member can be a cutting line or a plurality of holes. These holes can form a dashed line on the surface of the release layer. In addition, the holes can be of cylindrical type or rectangular solid type.

In the laminate with optical structure according to the invention, a sheet separation member is provided on the sheet with optical structure at the position corresponding to the release layer separation member. The sheet separation member can be a plurality of holes or a groove. The groove has V or U shape on the thickness cross-section of the sheet with optical structure.

In the laminate with optical structure according to the invention, an adhesive layer separation member is provided on the adhesive layer at the position corresponding to the release layer separation member. The adhesive layer separation member can comprise a plurality of holes. Besides, the holes can be of cylindrical type or rectangular solid type.

The sheet with optical structure can be formed by hot pressing an optical structured mold into one surface of a substrate or by a UV resin composition. Besides, the substrate is a thermoplastic film or sheet.

The adhesive layer can comprise hot melt adhesive or pressure sensitive hot melt adhesive. The release layer is a releasing film that can be released from the adhesive layer. The release layer can be an optically clear PET film.

The area of the release layer is larger than that of the adhesive layer for easily utilizing the laminate.

Moreover, the present invention discloses a method for using a laminate with optical structure. At first the laminate with optical structure according to this invention and an output body displaying a computer treated interlaced image for creating 2D or 3D effects are provided. A part of the laminate corresponding to the second portion of the release layer along the release separation member is bent to keep the second portion of the release layer away from the plane of the second portion of the release layer. Then, the second portion of the release layer is removed from the laminate with optical structure along the release separation member. The optical structure is aligned with the image by adjusting the relative position between the laminate and the output body. By pressing the part of the laminate corresponding to the second portion of the release layer, the part of the laminate is adhered with the output body by the adhesive layer. The first portion of the release layer is removed to adhere the laminate with the output body by the adhesive layer. In addition, a protection film can be adhered to the backside of the output body.

The output body can comprise a computer printout, a display, a light box or a backlight module. The method for using a laminate with optical structure according to the invention can further comprise removing the part of the laminate corresponding to the second portion of the release layer.

By removing a part of the release layer and keep the part of the laminate corresponding to the second portion of the release layer away from the alignment plane of the laminate and the output body, the adjustment of the relative position of the laminate and the output body can be carried out easily, smoothly, and precisely. After the correct position is found, the laminate and the output body can be adhered together by pressing down the part of the laminate that was previously bent away from the plane. Finally, the rest of the release layer can be removed to adhere the laminate and the output body gradually from the edge to prevent bubble enclosure.

Therefore, according to the present invention, laminating the laminate with optical structure with the interlaced image output can create lenticular effects.

### BRIEF DESCRIPTION OF THE DRAWINGS

FIG. 1 shows the method to create lenticular effects;

FIG. 2A shows the schematic structure of a laminate with optical structure according to the first embodiment of the present invention;

FIG. 2B shows a part of the bottom view of FIG. 2A;

FIGS. 3A to 3C show the method for using a laminate with optical structure according to the first embodiment of the present invention;

FIG. 4 shows the relative position of the optical structure and the interlaced image; and,

FIG. 5 shows a sheet separation member provided on the sheet with optical structure of the laminate wherein the upper view is the top view of the laminate and the lower view is the cross-section of the laminate.

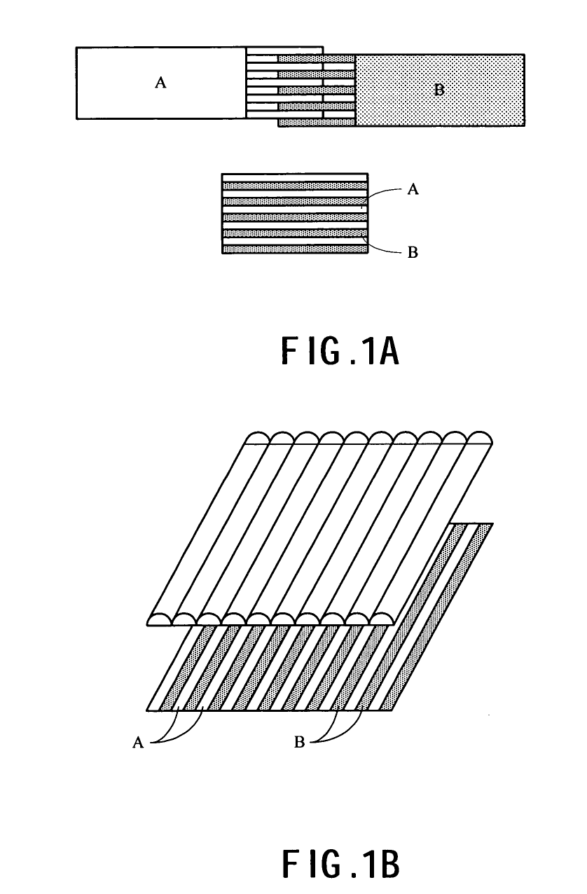

### DESCRIPTION OF THE PREFERRED EMBODIMENTS

What is probed into the invention is a laminate with optical structure and a method for using the same. Detail descriptions of the structure and elements will be provided in the following in order to make the invention thoroughly understood. Obviously, the application of the invention is not confined to specific details familiar to those who are skilled in the art. On the other hand, the common structures and elements that are known to everyone are not described in details to avoid unnecessary limits of the invention. Some preferred embodiments of the present invention will now be described in greater detail in the following. However, it should be recognized that the present invention can be practiced in a wide range of other embodiments besides those explicitly described, that is, this invention can also be applied extensively to other embodiments, and the scope of the present invention is expressly not limited except as specified in the accompanying claims.

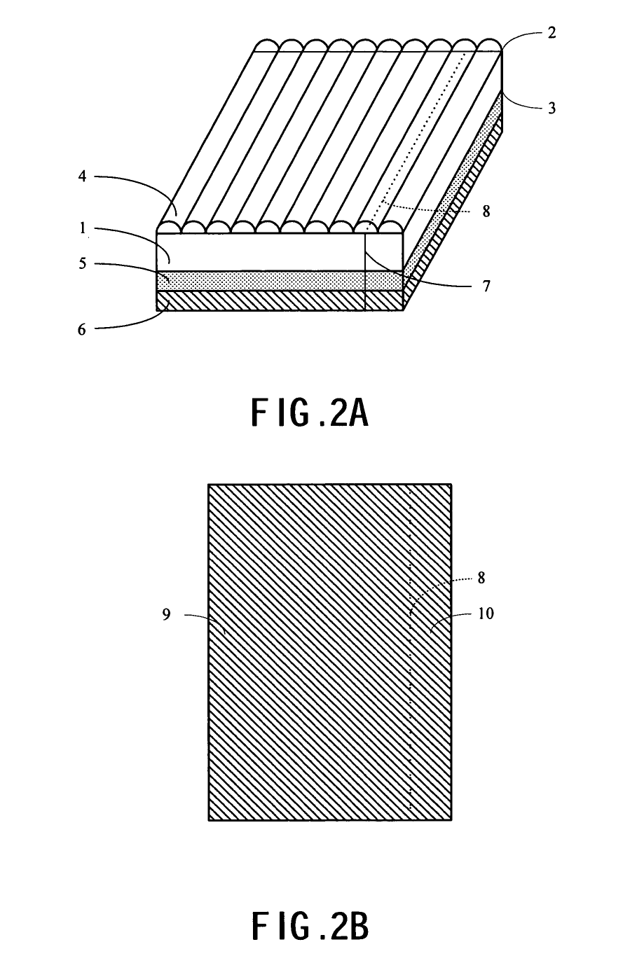

The first embodiment of the present invention discloses a laminate with optical structure as shown in FIG. 2A. A sheet 1 with optical structure 4 has a first surface 2 and a second surface 3 wherein a plurality of lenticular lens are formed on a first surface 2 of the sheet 1. The sheet 1 with optical structure 4 is formed by hot pressing an optical structured mold into one surface of a plastic sheet or direct extrusion or injection from thermoplastic resins through a embossing roller. The plastic sheet can be made of TPU (thermoplastic polyurethane), PVC (polyvinylene chloride), acrylates, and PET (polyethylene terephthalate), etc. An adhesive layer 5 is provided on the second surface 3 of the sheet 1. The adhesive layer 5 comprises hot meld adhesive. A release layer 6 is provided on the adhesive layer 5. As shown in FIG. 2A, the release layer 6 is divided by a release layer separation member 8 into a first portion 9 and a second portion 10 to let the area of the first portion 9 larger than that of the second portion 10.

FIG. 2B shows a part of the bottom view of FIG. 2A. A preferred configuration of the release layer separation member 8 is a dashed line, which comprises a plurality of holes 7 on the surface of the release layer 6. The holes 7 are cylindrical that can be formed by a hole puncher.

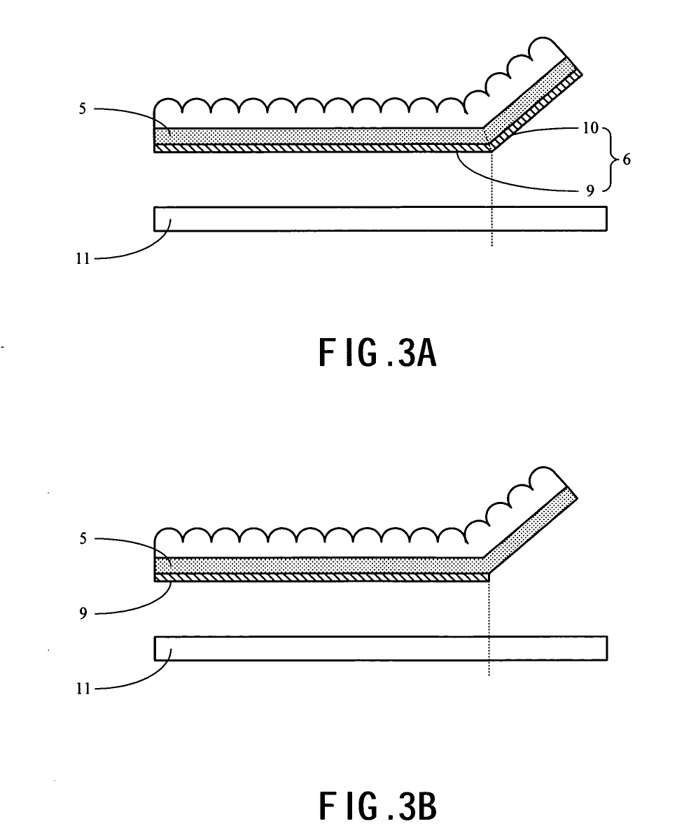

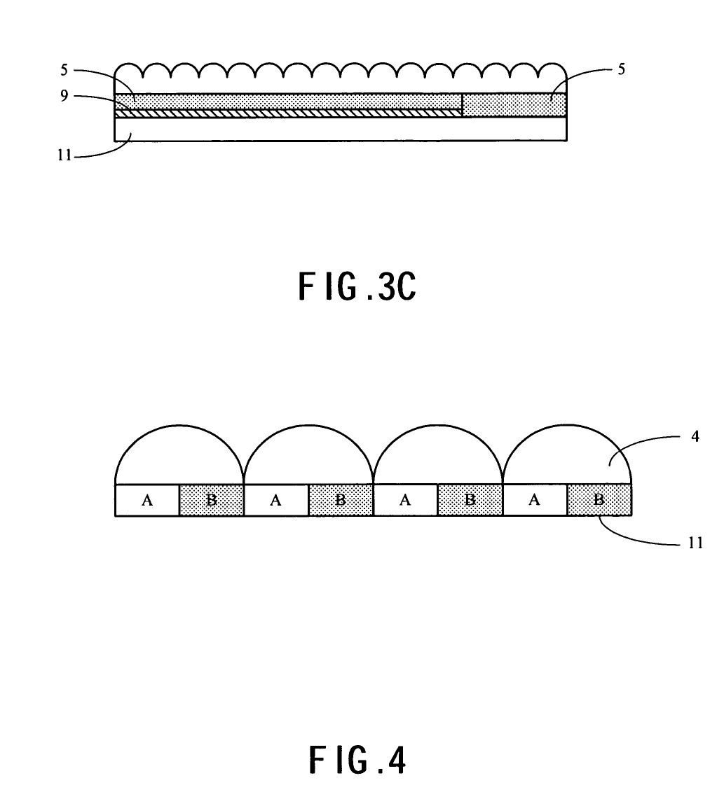

FIGS. 3A to 3C show the method for using a laminate with optical structure according to the first embodiment of the present invention. The laminate with optical structure according to this invention and an output body 11 displaying a computer treated image for creating 2D or 3D effects are provided. In order to align the output body 11 with the optical structure 4 to have the relative position as shown in FIG. 4. At first, a part of the laminate corresponding to the second portion 10 of the release layer along the release separation member 8 is bent to keep the second portion 10 of the release layer away from the plane of the first portion 9 of the release layer, as shown in FIG. 3A. Then, the second portion 10 of the release layer is removed from the laminate with optical structure along the release separation member 8, as shown in FIG. 3B. After aligning the optical structure with the image by adjusting the relative position of the laminate and the output body 11, the part of the laminate corresponding to the second portion 10 of the release layer is pressed to be adhered with the output body 11 by the adhesive layer 5, as shown in FIG. 3C. Finally, the first portion 9 of the release layer is removed to have the laminate adhered with the output body 11 by the adhesive layer 5. The part of the laminate corresponding to the second portion 10 of the release layer may be cut out along the release separation member 8.

The second embodiment of the present invention discloses a laminate with optical structure that is the same as the first embodiment except the sheet with optical structure formed by a UV curable resin composition. The method for using the laminate with optical structure according to the second embodiment of the present invention is the same as the first embodiment.

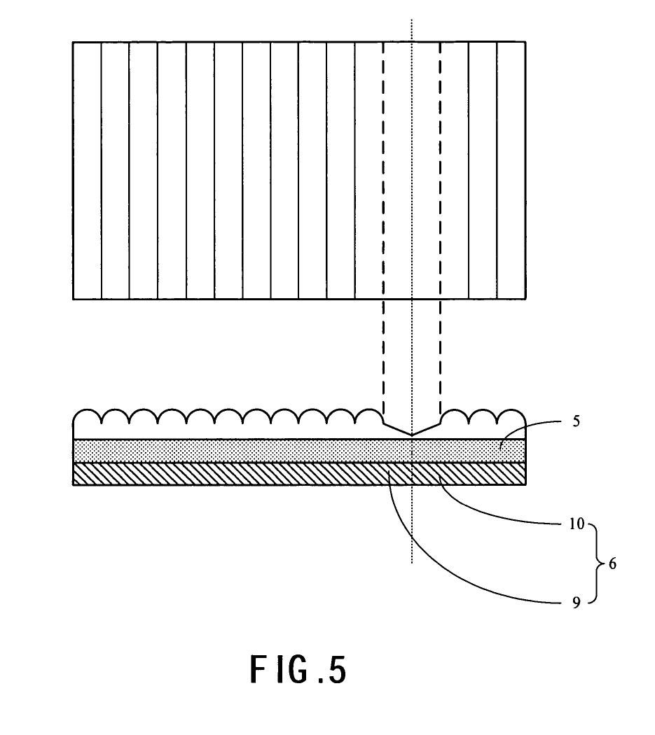

The third embodiment of the invention discloses a laminate with optical structure that is the same as the first embodiment except a sheet separation member provided on the sheet with optical structure. As shown in FIG. 5, the sheet separation member comprises a V groove. The V groove can be formed by a lathe. Specifically, it is convenient for a thick laminate during bending a part of the laminate corresponding to the second portion 10 of the release layer along the release separation member 8. The method for using the laminate with optical structure according to the third embodiment of the present invention is the same as the first embodiment.

The fourth embodiment of the invention discloses a laminate with optical structure that is the same as the third embodiment except the sheet separation member comprises a U groove. The method for using the laminate with optical structure according to the fourth embodiment of the present invention is the same as the third embodiment.

The fifth embodiment of the invention discloses a laminate with optical structure that is the same as the first embodiment except an adhesive layer separation member and a sheet separation member formed together with the holes 7 while using the hole puncher on the laminate to produce through holes. The method for using the laminate with optical structure according to the fifth embodiment of the present invention is the same as the first embodiment except that he part of the laminate corresponding to the second portion of the release layer is removed and a protection film is attached to the backside of the output body 11.

To sum up, the present invention discloses a laminate with optical structure to solve the alignment difficulty problem in creating lenticular effects utilizing lenticular lens. Furthermore, the present invention discloses a method for using the laminate.

Obviously many modifications and variations are possible in light of the above teachings. It is therefore to be understood that within the scope of the appended claims the present invention can be practiced otherwise than as specifically described herein. Although specific embodiments have been illustrated and described herein, it is obvious to those skilled in the art that many modifications of the present invention may be made without departing from what is intended to be limited solely by the appended claims.

What is claimed is:

1. A laminate with optical structure, comprising:
a sheet with optical structure having a plurality of lenticular lens on one surface of the sheet;
an adhesive layer formed on the other surface of the sheet and covering the whole or part of the surface;
a release layer provided on the adhesive layer and covering at least the whole surface of the adhesive layer, and divided by a release layer separation member into a first portion and a second portion, wherein the area of the first portion is larger than that of the second portion.

2. The laminate with optical structure according to claim 1, wherein the release layer separation member is a cutting line or a plurality of holes.

3. The laminate with optical structure according to claim 2, wherein the holes form a dashed line on the surface of the release layer.

4. The laminate with optical structure according to claim 2, wherein the holes are of cylindrical type or rectangular solid type.

5. The laminate with optical structure according to claim 1, wherein a sheet separation member is provided on the sheet with optical structure at the position corresponding to the release layer separation member.

6. The laminate with optical structure according to claim 5, wherein the sheet separation member is a plurality of holes or a groove.

7. The laminate with optical structure according to claim 6, wherein the groove has V or U shape on the thickness cross-section of the sheet with optical structure.

8. The laminate with optical structure according to claim 6, wherein the holes are of cylindrical type or rectangular solid type.

9. The laminate with optical structure according to claim 1, wherein an adhesive layer separation member is provided on the adhesive layer at the position corresponding to the release layer separation member.

10. The laminate with optical structure according to claim 9, wherein the adhesive layer separation member comprises a plurality of holes.

11. The laminate with optical structure according to claim 1, wherein the sheet with optical structure is formed by hot pressing an optical structured mold into one surface of a substrate and the substrate is a thermoplastic sheet.

12. The laminate with optical structure according to claim 1, wherein the sheet with optical structure is formed by a resin composition.

13. The laminate with optical structure according to claim 12, wherein the resin composition is ultraviolet radiation curable.

14. The laminate with optical structure according to claim 1, wherein the adhesive layer comprises hot melt adhesive or pressure sensitive hot melt adhesive.

15. The laminate with optical structure according to claim 1, wherein the release layer is transparent.

16. The laminate with optical structure according to claim 1, wherein the area of the release layer is larger than that of the adhesive layer.

17. A method for using a laminate with optical structure, comprising:
providing the laminate with optical structure according to claim 1;
providing an output body, wherein the output body has a first surface displaying a interlaced image and a second surface, and the first surface is opposite to the second surface;
bending a part of the laminate corresponding to the second portion of the release layer along the release separation member to keep the second portion of the release layer away from the plane of the second portion of the release layer;
removing the second portion of the release layer from the laminate with optical structure along the release separation member;
aligning the optical structure with the interlaced image;
pressing the part of the laminate corresponding to the second portion of the release layer to adhere the part of the laminate with the first surface of the output body by the adhesive layer; and,
removing the first portion of the release layer to adhere the laminate with the first surface of the output body by the adhesive layer.

18. The method for using a laminate with optical structure according to claim 17, further comprising removing the part of the laminate corresponding to the second portion of the release layer.

19. The method for using a laminate with optical structure according to claim 17, further comprising attaching a protection layer to the second surface of the output body.

20. The method for using a laminate with optical structure according to claim 17, wherein the output body is selected from a group consisting of the following: a computer printout, a display, a light box, and a backlight module.
